(19) United States
(12) Patent Application Publication
(10) Pub. No.: US 2025/0381880 A1
(43) Pub. Date: Dec. 18, 2025

(54) REPLACEMENT SYSTEM FOR ELECTRICAL POWER SOURCES OF POWER MACHINES

(71) Applicant: Doosan Bobcat North America, Inc., West Fargo, ND (US)

(72) Inventors: Jason Drost, Fort Atkinson, WI (US); Justin Stefanko, Waukesha, WI (US)

(21) Appl. No.: 19/240,792

(22) Filed: Jun. 17, 2025

Related U.S. Application Data
(60) Provisional application No. 63/660,614, filed on Jun. 17, 2024.

(51) Int. Cl. B60L 53/80; B60L 1/00; B60L 50/60; B60L 53/36

(52) U.S. Cl. CPC B60L 53/80; B60L 1/003; B60L 50/66; B60L 53/36; B60L 2200/40

(57) ABSTRACT

A power machine can include a power machine frame that supports one or more work elements, a battery support assembly, and a power source. The battery support assembly can include a lift assembly that is secured to the power machine frame and includes at least one movable link and a lift actuator, and a lift bracket that is movably supported relative to the power machine frame by the at least one movable link. The power source can include a power source frame that includes a support bracket and an electrical power source supported by the power source frame.

### CROSS-REFERENCE TO RELATED APPLICATIONS

This application claims the benefit of U.S. Provisional Patent Application No. 63/660,614, filed Jun. 17, 2024, which is hereby incorporated by reference in its entirety.

### BACKGROUND

This disclosure is directed toward power machines. More particularly, this disclosure is directed towards systems of a power machine for power delivery, including for tractive, auxiliary, and external operations. Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders (including mini loaders), excavators, utility vehicles, mowers, tractors (including compact tractors), and trenchers, to name a few examples.

Conventional power machines can include various systems and related components that are configured to use output from a power source (e.g., an electric motor) to perform different work functions. More specifically, the power source can transmit power to a power conversion system (e.g., a drive motor) to power a movement of a power machine or an implement or execute other operations.

The discussion above is merely provided for general background information and is not intended to be used as an aid in determining the scope of the claimed subject matter.

### SUMMARY

Power machines and related systems and methods as disclosed herein, including compact articulated tractors in particular, can include different systems to improve functionality and structure of the machine. For example, among other improvements, different implementations can provide power machines with an improved power source that is exchangeable.

Some examples provide a power machine with a power machine frame that supports one or more work elements, a support assembly, and a power source. The support assembly can include a lift assembly that is secured to the power machine frame and includes at least one movable link and a lift actuator. Further, the support assembly can include a lift bracket that is movably supported relative to the power machine frame by the at least one movable link. The power source can include a power source frame that includes a support bracket and an electrical power source that is supported by the power source frame. The electrical power source can be supported by the support assembly to power the one or more work elements. The lift bracket can removably engage the support bracket to support the power source relative to the power machine frame with the lift assembly selectively in any one of a raised position, a lowered position, and a plurality of intermediate positions between the raised and lowered positions. Further, the lift actuator can be operable to move the lift assembly, including the at least one movable link, through the intermediate positions between the raised and lowered positions.

In some examples, the power machine frame can be an articulated frame, with a front frame pivotable relative to a rear frame. The support assembly can be supported on the rear frame.

In some examples, the lift assembly can include a multi-bar linkage that includes the at least one movable link. In some examples, the multi-bar linkage can include a four-bar linkage. In some examples, the multi-bar linkage is configured to tilt a top end of the lift bracket to towards the support bracket as the lift assembly lowers toward the lowered position.

In some embodiments, the lift actuator can be pivotally secured at a first end relative to the power machine frame and pivotally secured at a second end to the lift assembly. In some examples, the lift actuator can be pivotally secured to an upper link of a four-bar linkage of the lift assembly via a pivoting offset link.

In some examples, the support assembly can include a guide plate with a guide slot, rigidly secured relative to the power machine frame. The lift actuator can be pivotally secured to the lift assembly via a guide member that extends through the guide slot.

In some examples, the lift bracket can define a peaked (e.g., upper) bracket profile. The power source frame can define a peaked (e.g., upper) frame profile. The peaked bracket profile can be received into the peaked frame profile to support the power source relative to the power machine frame. In some examples, the power source frame can include a tapered guide and the lift bracket can include a protrusion. The protrusion can be arranged to move through the tapered guide to align the peaked frame profile with the peaked bracket profile.

In some examples, one or more of the support assembly, the power machine frame, or the power source can support a locking member arranged for movement into and out of an engaged position to secure the power source relative to the power machine frame.

In some examples, one or more of the power machine frame or the support assembly can support a first electrical connector. The power source can include a second electrical connector. The lift assembly can support the power source to align the first electrical connector and the second electrical connector for operational connection to power the one or more work elements.

In some examples, the power machine can include an electronic locking device (e.g., a solenoid assembly) arranged to engage the first and second electrical connectors together for transmission of power from the power source to power the one or more work elements.

In some examples, the power source can further include a trailer hitch or a trailer hitch receiver.

Some examples provide a support assembly for an electrical power source (e.g., a battery) of a power machine. The support assembly can include a lift assembly that is securable to a power machine frame of the power machine at first pivotable joints. The lift assembly can include a four-bar linkage and a lift actuator that is arranged to move the four-bar linkage relative to the first pivotable joints. Further, the support assembly can include a lift bracket that is movably supported by the four-bar linkage. The lift bracket can include a peaked (e.g., upper) profile that is configured to be received into a peaked (e.g., upper) profile of a power source that includes the electrical power source.

In some examples, the support assembly can include one or more solenoid assemblies. The one or more solenoid assemblies can be configured to selectively secure the power source to the lift bracket. The one or more solenoid assemblies can be configured to engage an electrical connector of the support assembly with the power source to receive power from the power source.

In some examples, the lift bracket can include a protrusion that is configured to align the peaked profile of the lift bracket with the peaked profile of the power source. In some examples, the lift bracket can be configured to tilt rearwardly as the lift assembly moves the four-bar linkage to lower the lift bracket.

Some examples provide a power source for an electrically powered power machine. The power source can include a power source frame that includes a support bracket and an electrical power source that is supported by the power source frame. The support bracket can include a peaked (e.g., upper) profile configured to receive a peaked (e.g., upper) profile of a battery support assembly of the electrically powered power machine.

Some examples provide a method of swapping a power source for a power machine. The power machine can be aligned with the power source so that a support bracket of the power source is aligned with a lift assembly of a battery support assembly secured to a power machine frame of the power machine. A lift bracket of the lift assembly can be engaged with the support bracket of the power source so that the lift assembly supports the power source relative to the power machine frame. Additionally, an electrical power source can be supported by a power source frame of the power source. A lift actuator of the lift assembly can be operated to move the lift assembly from a lowered position, through a plurality of intermediate positions, to a raised position for operation of the power machine under power from the electrical power source.

In some examples, the lift assembly can include a four-bar linkage that supports the lift bracket relative to the power machine frame.

In some examples, aligning the support bracket with the lift assembly can align a peaked (e.g., upper) profile of the lift bracket to be received into a peaked (e.g., upper) profile of the support bracket. Lowering the lift assembly to the lowered position can cause a top end of the lift bracket to tilt towards the support bracket to align the peaked profiles.

In some examples, the method of swapping the power source for the power machine can include operating a first electronic locking device (e.g., solenoid) to secure the support bracket to the lift bracket, after engaging the lift bracket with the support bracket. In some examples, the method can include, after operating the first electronic locking device to secure the support bracket to the lift bracket, operating a second electronic locking device (e.g., solenoid) to electrically connect the power source for transmission of power to one or more work elements of the power machine.

In some examples, lowering the lift assembly to the lowered position can cause a top end of the lift bracket to tilt towards the support bracket.

This Summary and the Abstract are provided to introduce a selection of concepts in a simplified form that can be further described below in the Detailed Description. This Summary and the Abstract are not intended to identify key features or essential features of the claimed subject matter, nor are they intended to be used as an aid in determining the scope of the claimed subject matter.

### DRAWINGS

The following drawings are provided to help illustrate various features of non-limiting examples of the disclosure and are not intended to limit the scope of the disclosure or exclude alternative implementations.

FIG. 1 is a block diagram illustrating functional systems of a representative power machine on which examples of the present disclosure can be advantageously practiced.

FIG. 2 is a block diagram illustrating components of a power source of a compact tractor or other configuration of the power machine of FIG. 1.

FIG. 3 illustrates an axonometric view of a representative power machine in the form of a compact tractor.

FIG. 4 illustrates an axonometric view of a representative power machine in the form of a compact tractor, according to an implementation of the systems of FIGS. 1 and 2.

FIG. 5 is a side cross-sectional view of the compact tractor of FIG. 4, taken along a vertical mid-plane of the compact tractor.

FIG. 6 is a bottom, rear axonometric view of a power source of the compact tractor of FIG. 4 according to an example of the disclosure.

FIG. 7 is a top, front axonometric view of the power source of FIG. 6.

FIG. 8 is a top, rear axonometric view of a lift assembly of the compact tractor of FIG. 4.

FIG. 9 is a top, rear axonometric view of a power source of the compact tractor of FIG. 4, according to an example of the disclosure.

FIG. 10 is a top, rear axonometric view of the power source of FIG. 9 showing details of a power source frame.

FIG. 11 is a rear axonometric view of a battery support assembly of the compact tractor of FIG. 4, according to an example of the disclosure.

FIG. 12 is a side elevation partial view of the compact tractor of FIG. 4 showing the battery support assembly of FIG. 11 in a fully lowered position.

FIG. 13 is an axonometric partial view of the compact tractor of FIG. 4 showing the battery support assembly of FIG. 11 in the fully lowered position of FIG. 12.

FIG. 14 is a side elevation partial view of the compact tractor of FIG. 4 showing the battery support assembly of FIG. 11 in an intermediate position.

FIG. 15 is an axonometric partial view of the compact tractor of FIG. 4 showing the battery support assembly of FIG. 11 in the intermediate position of FIG. 14.

FIG. 16 is a side elevation partial view of the compact tractor of FIG. 4 showing the battery support assembly of FIG. 11 in a fully raised position.

FIG. 17 is an axonometric partial view of the compact tractor of FIG. 4 showing the battery support assembly of FIG. 11 in the fully raised position of FIG. 16.

### DETAILED DESCRIPTION

The concepts disclosed in this discussion are described and illustrated by referring to exemplary configurations. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Conventional power machines can include a power source that delivers power to various parts of the power machine to perform different work functions. For example, the power source can be an electrical battery pack that is rechargeable at a charging station or other electrical power source configured to power tractive or workgroup operations of a power machine. When stored energy of the power source is low, an operator may need to bring the power machine to the charging station and wait for the power source to be charged before returning to work. In some cases, however, it may be desirable to simply swap out a drained battery pack (or other power source) for a more fully charged replacement.

Examples of the disclosed technology can address these or other issues. In particular, some embodiments of the disclosed technology can provide configurations of electric power sources and associated support structures that allow the electric power source to be exchanged with another electric power source (e.g., at a designated station).

In some embodiments, the power source can be mounted on a power source frame and be coupled to the power machine (e.g., via a frame of the power machine). When the power source is ready to be swapped (e.g., when the power machine receives a signal that the power source is at a low energy level), the power machine can be returned (e.g., automatically) to a docking (or other) location to swap out the power source with another power source that may have a higher (e.g., full) energy level. In particular, the power source can be electrically disconnected and mechanically decoupled from the power machine, and the replacement power source can be mechanically coupled and electrically connected to the power machine instead. In some cases, the power source, as supported by the power machine frame, can be lowered or raised to aid with the swapping process.

More specifically, an embodiment of the disclosed technology can include a battery support system that can use a linkage or other structural arrangement to move a swappable power source between installed and uninstalled configurations as part of a swapping process for a power machine. For example, the battery support system can be anchored to a power machine frame at one or more locations, and can include movable support members configured to be coupled to a power source (e.g., at a particular lift interface) to allow controlled (e.g., prescribed) movement of a power source between a staged position (e.g., at a charging station) and an installed configuration (e.g., with the power source mechanically secured and electrically connected relative to the power machine frame). In some examples, a battery support system can include a plurality of links connected at a plurality of joints, and the plurality of links can move relative to one another to move (e.g., raise or lower) the power source. In some cases, the battery support system can be a four-bar linkage system. For example, kinematics of some four-bar linkage systems can advantageously support the power source at a relatively level height throughout a range of movement or help to maximize a vertical component of the movement of the power source (e.g., to reduce the need to support the power source at a long lever arm relative to the power machine). Correspondingly, some multi-point linkage systems can provide a battery support system with a greater degree of freedom for moving the power source.

Some embodiments of the disclosed technology can include electronic locking devices, which may include solenoid assemblies or other automated engagement devices (e.g., motor-operated cams or pins) to connect various parts of the power machine with a swappable power source (e.g., structurally or operatively). For example, when a battery support system has moved to align a power source to power operation of the relevant power machine, a solenoid can be controlled to secure the power source to the power machine (e.g., to pin the power source directly to a frame of the power machine). In some cases, an additional solenoid can be activated to connect an electrical connector to the power source to establish an electrical connection for powered operation of the relevant power machine. Thus, the solenoids or other electronic locking devices can allow a connection between the power machine and the power source with a high degree of robustness and accuracy.

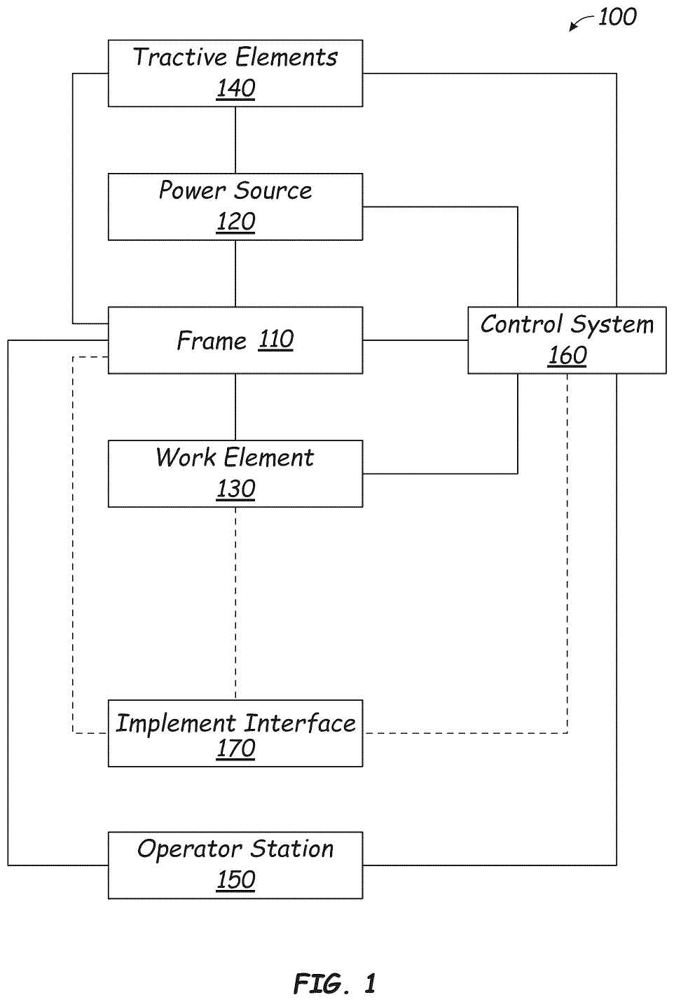

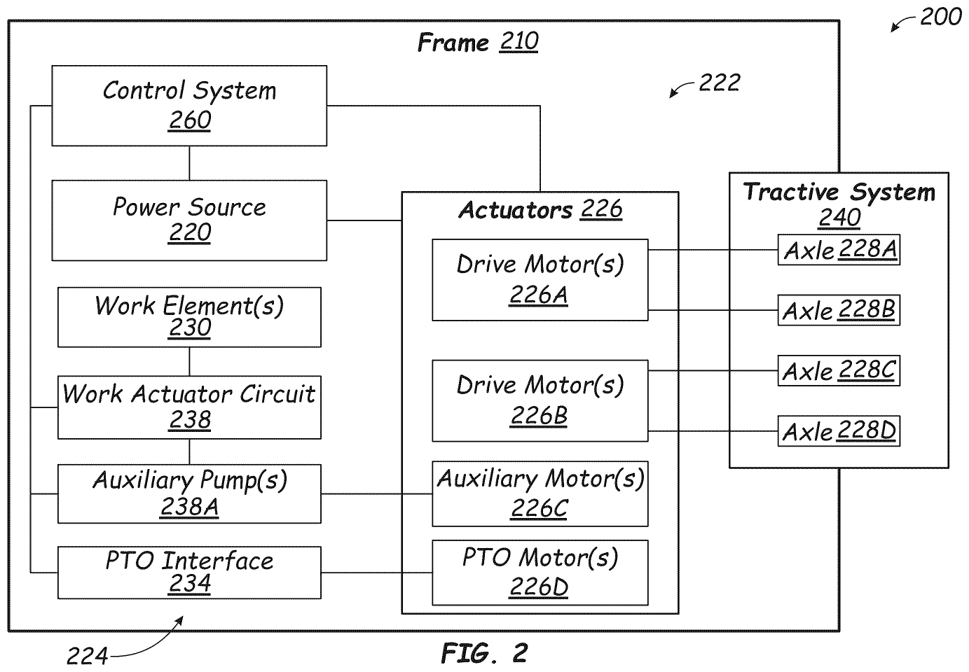

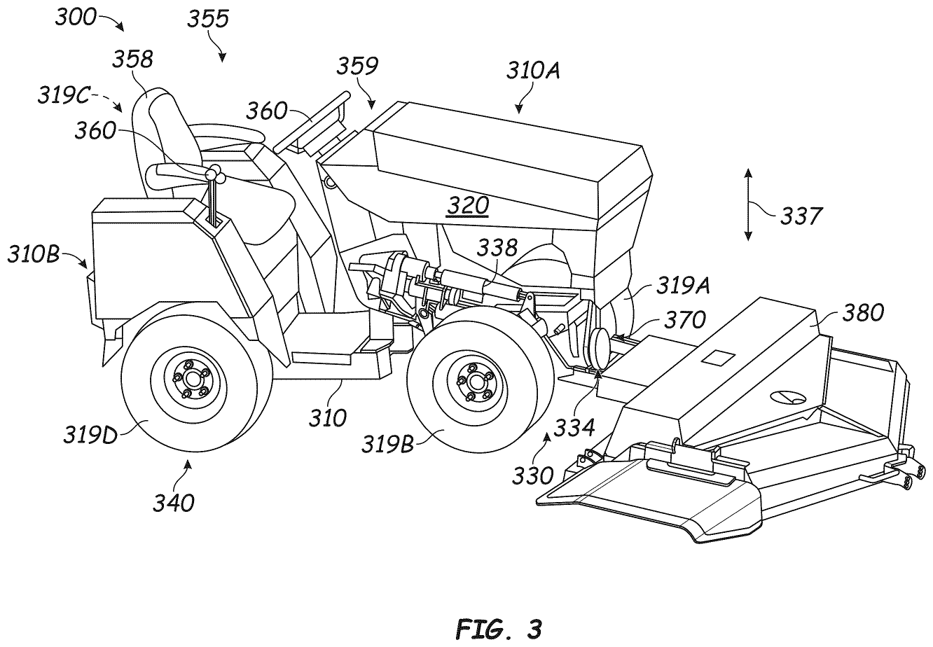

These concepts can be practiced on various power machines, as will be described below. Representative configurations of power machines on which the examples of the disclosed technology can be practiced are illustrated in diagram form in FIGS. 1 and 2, and generally illustrated in FIG. 3. For the sake of brevity, only one power machine is illustrated and discussed as being a representative power machine. However, as mentioned above, the examples below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

FIG. 1 is a block diagram that illustrates the basic systems of a power machine 100, which can be any of a number of different types of power machines upon which the examples discussed below can be advantageously incorporated. The block diagram of FIG. 1 both identifies various systems on power machine 100 and shows relationships between various components and systems. At the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to selectively move the power machine over a support surface. The power machine 100 also includes an operator station 150 that provides an operating position where an operator can manipulate operator inputs for controlling the work elements of the power machine (e.g., a cab, an open station with an operator seat or standing pad, etc.).

A control system 160 is provided to interact with the other systems to perform various work tasks at least in part in response to control signals provided by an operator. For example, the control system 160 can be an integrated or distributed architecture of one or more processor devices and one or more memories that are collectively configured to receive operator input or other input signals (e.g., sensor data) and to output commands accordingly for power machine operations. For example, the control system 160 can include one or more general or special-purpose electronic computers of various generally known designs. According to some examples, the control system 160 can include a hydraulic circuit provided to interact with other systems to perform various work tasks at least in part in response to signals given by an operator by way of movement of input devices arranged on the power machine 100 (e.g., within the operator station 150). Generally, the control system 160 can include or be in communication with various input devices, including operator input devices (e.g., joysticks, pedals, touchscreens, etc.), sensors distributed on or around the power machine 100, or output ports for various other components (e.g., electronic output ports of electric motors or other equipment).

Certain work vehicles have work elements 130 that can perform a dedicated task. For example, some work vehicles have a lift arm to which various implements can be attached by a pinning or other arrangement (e.g., buckets, grapples, mower decks, etc.). A lift arm, as a form of a work element, can be manipulated by various actuators to position an implement to perform a task.

Some power machines may include removable work elements, including as can be in the form of a wide variety of implements that can be attached to the power machine frame 110 via an implement interface 170. At its most basic, the implement interface 170 is a connection mechanism between the frame 110 or a work element 130 and an implement, which can be as simple as a pivoting or other connection point for attaching an implement directly to the frame 110 (or another work element 130) or can include more complex arrangements, including implement carriers.

On some power machines, the implement interface 170 can include, as an implement carrier, a physical structure movably attached to a work element (e.g., lift arm) and removably attachable to one or more implements. In this regard, the implement carrier can have engagement features and locking features to accept and secure any of a number of different implements to the work element. In some implementations, once an implement is attached to an implement carrier, the implement is fixed relative to the implement carrier so that when the implement carrier is moved with respect to the frame 110, the implement moves with the implement carrier. (The term implement carrier as used herein is not merely a pivotal connection point, but rather a dedicated device specifically intended to accept and be secured to various different implements.) An implement carrier can be mountable to a work element 130 such as a lift arm, or to the frame 110. The implement interface 170 can also include one or more power sources for providing power to one or more work elements on an implement.

Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles, including some compact tractors, have articulated frames such that one portion of the frame pivots with respect to another portion for accomplishing at least a portion of the machine movement related to steering functions.

Frame 110 supports the power source 120, which is configured to provide power to one or more work elements 130 including the one or more tractive elements 140, as well as, in some instances, providing power for use by an operably coupled implement via implement interface 170 (e.g., via one or more hydraulic connections on or near the implement interface 170). Power from the power source 120 can be provided directly to any of the work elements 130, tractive elements 140, and implement interfaces 170. Alternatively, power from the power source 120 can be provided to a control system 160, which in turn selectively provides power to the elements that are capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electrical sources or a combination of different types of power sources (e.g., electric power sources and engines), known generally as hybrid power sources.

FIG. 1 shows a single work element designated as work element 130, but various power machines can have any number of work elements. Work elements are typically attached to the frame of the power machine and movable with respect to the frame when performing a work task. In some examples, as also discussed above, work elements can include lift arm assemblies. In some examples, work elements can include mower decks or other similar equipment. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame. In contrast, workgroup work elements are configured to implement non-drive operations (e.g., moving or otherwise operating various implements) and can correspondingly include actuators for movement of a lift arm or implement, or various other work elements.

Power machine 100 includes an operator station 150 that includes an operating position from which an operator can control operation of the power machine. In some power machines, the operator station 150 is defined by an enclosed or partially enclosed cab. Some power machines on which the disclosed technology may be practiced may not have a cab or an operator compartment of the type described above. For example, a walk behind loader may not have a cab or an operator compartment, but rather an operating position that serves as an operator station from which the power machine is properly operated. As another example, many compact tractors do not have a cab to enclose its operator station. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both of the power machine and any implement to which is it coupled) that is capable of controlling at least some of the operator-controlled functions on the power machine.

FIG. 2 illustrates an example of an electrically powered compact tractor 200, which is one particular example of the power machine 100 illustrated in FIG. 1. To that end, features of the tractor 200 described below include reference numbers that are generally similar to those used in FIG. 1. For example, the tractor 200 has a frame 210, just as power machine 100 has a frame 110. The tractor 200 is described herein to provide a reference for understanding one environment on which the examples described below related to hydraulic drive and auxiliary hydraulic control systems and methods may be practiced. The tractor 200 should not be considered limiting especially as to the description of features that tractor 200 may have described herein that are not essential to the disclosed examples and thus may or may not be included in power machines other than the tractor 200 upon which the examples disclosed below may be advantageously practiced. Unless specifically noted otherwise, examples disclosed below can be practiced on a variety of power machines, with the tractor 200 being only one of those power machines. For example, some or all of the concepts discussed below can be practiced on many other types of work vehicles such as various other loaders, excavators, trenchers, and dozers, to name but a few examples.

The frame 210 of the tractor 200 supports a power source 222 that can generate or otherwise providing power for operating various functions on the power machine. In particular, the power source 222 can include an electric power source 220 configured to supply electric power for power machine operations (e.g., a battery assembly, a generator, a capacitor system, etc.), as well as a power conversion system 224 arranged to utilize the power from the power source 220 for useful power machine operations.

In particular, the power conversion system 224 of the tractor 200 can include various components, including mechanical transmissions, hydraulic systems, various motors or other actuators, and the like. In some examples, the power conversion system 224 of the tractor 200 includes one or more electric drive motors 226A, 226B, which can be powered by the power source 220 and can be selectively controllable (e.g., via the control system 260) to provide a power to drive axles 228A-228D or other tractive assemblies of a tractive system 240. In some examples, as further discussed below, a first drive motor 226A can power a first set of axles (e.g., axles 228A, 228B) and a second drive motor 226B can power a second set of axles (e.g., axles 228C, 228D) that are connected to corresponding tractive elements (e.g., wheels or tracks, not shown in FIG. 2). However, other configurations are possible, including with a respective dedicated motor for each axle, with only front or only rear axles being powered, and so on.

The power conversion system 224 of tractor 200 also includes an auxiliary motor 226C that can be powered by the power source 220 and controlled by the control system 260 to provide rotational power to one or more corresponding auxiliary pumps 238A. The auxiliary pumps 238A can thus be operated, using electric power from the power source 220, to provide hydraulic flow for various power machine functions. In particular, for example, the auxiliary pump(s) 238A may provide hydraulic flow to a work actuator circuit 238 that can be configured to operate a lift arm, implement, or other work element 230 (e.g., using various known hydraulic valves, actuators, controllers, and so on).

In some cases, the actuators 226 of the power conversion system 224 can include one or more power take-off (PTO) motors 226D. For example, the PTO motor(s) 226D can be operated using power from the power source 220, as controlled by the control system 260, to provide rotational power to an output shaft or other form of PTO interface 234. For example, a belt-driven or other power transfer system (e.g., a chain drive system, a rope drive system, a gear drive system, a slew drive system, etc.) can be provided to transmit rotational power from the PTO motor 226D to the PTO interface 234.

FIG. 3 illustrates an example compact tractor 300, which is one particular example of a power machine 100 of FIG. 1 or the tractor 200 of FIG. 2, where the examples discussed below can be advantageously employed. To that end, features of the tractor 300 described below include reference numbers that are generally similar to those used in FIGS. 1 and 2 and discussion of above applies to similar numbers below unless otherwise noted or required. For example, the tractor 300 is described as having a frame 310, just as power machine 100 has a frame 110. However, the tractor 300 as illustrated should not be considered limiting, and examples disclosed below can also be practiced on a variety of other power machines.

The frame 310 of the tractor 300 supports a power source 320 that is capable of generating or otherwise providing power for operating various functions on the power machine. In particular, the power source 320 can include an electric power source (e.g., a battery assembly) in some examples. Power source 320 is shown in block diagram form and is located within the frame 310 so as not visible in FIG. 3. In other examples, however, the power source 320 can be differently located, including at locations external to the frame 310 or with support for powered movement to and from an installed orientation (e.g., to swap the power source 320 for another, as further detailed below).

In particular, the frame 310 can be an articulating frame. Accordingly, a front frame portion 310A supported by front wheels 319A, 319B can be moved along one or more degrees of freedom (e.g., pivoted about a vertical or a horizontal axis) relative to a rear frame portion 310B supported by the rear wheels 319C, 319D (wheel 319C hidden from view in FIG. 3). In other examples, however, non-articulated or differently articulated frames can be used.

The frame 310 also supports a work element in the form of a lift arm assembly 330 that is powered by the power source 320 and that can perform various work tasks. As the tractor 300 is a work vehicle, the frame 310 also supports a traction system 340, which is also powered by power source 320 and can propel the power machine over a support surface. The lift arm assembly 330 in turn supports an implement (e.g., accessory) interface 370 that can receive and secure various implements to the tractor 300 for performing various work tasks. In some examples, the implement interface 370 (or other sub-system) can include power couplers, to which an implement can be coupled to receive hydraulic or electric power from the power source 320. In some examples, a PTO interface 334 can be provided (e.g., a pully-operated output shaft). Power couplers can provide sources of hydraulic or electric power or both.

The tractor 300 includes an operator station 355 from which an operator can manipulate various control devices 360 to cause the tractor 300 to perform various work functions. In the illustrated example, the operator station 355 includes an operator seat 358 and a plurality of operation input devices, including control levers and a steering wheel (e.g., control devices 360) that an operator can manipulate to control various machine functions, including as steering functions, drive functions, and auxiliary hydraulic functions (i.e., pressurized hydraulic flow made selectively available to an operably coupled implement). Operator input devices can include various human-machine interfaces including buttons, switches, levers, sliders, pedals, touchscreens, and the like that can be stand-alone devices such as hand-operated levers or foot-operated pedals, incorporated into hand grips, or incorporated into display panels, which may be included on the dashboard 359, including programmable input devices. Actuation of operator input devices can generate signals in the form of electrical signals, hydraulic signals, or mechanical signals. Signals generated in response to operator input devices are provided to various components on the power machine for controlling various functions on the power machine (e.g., to or via one or more electronic controllers of a larger electronic control system). Among the functions that can be controlled via operator input devices on tractor 300 include control of tractive elements of the traction system 340, the lift arm assembly 330, the implement interface 370, and providing signals to any implement that may be operably coupled to the implement.

Other power machines, including walk behind power machines may not have a cab nor an operator compartment, nor a seat. The operator position on such power machines is generally defined relative to a position where an operator can access and manipulate relevant operator input devices.

Various power machines that can include or interacting with the examples discussed below can have various different frame components that support various work elements. The frame 310 discussed herein can include many elements, however the frame 310 is not the only type of frame that a power machine on which the disclosed technology can be practiced can employ. For example, the frame 310 of tractor 300 can include an undercarriage or lower portion of the frame 310 and a mainframe or upper portion of the frame 310 that is supported by the undercarriage. The mainframe of tractor 300, in some examples, is attached to the undercarriage such as with fasteners or by welding the undercarriage to the mainframe. Alternatively, the mainframe and undercarriage can be integrally formed. The frame 310 also supports a set of tractive elements in the form of the wheels 319A-D at the front and back of both sides of the tractor 300.

The lift arm assembly 330 shown in FIG. 3 is one example of many different types of lift arm assemblies that can be attached to a power machine such as tractor 300 or other power machines on which examples of the present discussion can be practiced. The lift arm assembly 330 is moveable using actuators 338 (e.g., hydraulic cylinders), to change position of the lift arm assembly 330 along a lift path 337 with respect to the frame 310 (e.g., to raise and lower the lift arm assembly as desired). Other lift arm assemblies can have different geometries and can be coupled to the frame of a loader in various ways to provide lift paths. For example, some lift arm assemblies are configured to provide a vertical lift path, while others are configured to provide a radial lift path. Other lift arm assemblies can have an extendable or telescoping portion. Other power machines can have a plurality of lift arm assemblies attached to their frames, with each lift arm assembly being independent of the other(s). Unless specifically stated otherwise, none of the inventive concepts set forth in this discussion are limited by the type or number of lift arm assemblies that are coupled to a particular power machine.

Some lift arms, most notably lift arms on excavators but also possible on loaders, may have portions that are controllable to pivot with respect to another segment instead of moving in concert (i.e., along a pre-determined path). Some power machines have lift arm assemblies with a single lift arm, such as is known in excavators or even some loaders and other power machines. Other power machines can have a plurality of lift arm assemblies, each being independent of the other(s), or a variety of other work elements.

Generally, implements can be located generally forward of a front of the tractor 300 (or at other locations), including implements that include or provide any suitable accessory for the tractor 300. For example, an implement 380 can be configured as a lawn mower deck (e.g., as shown), a snow blower, a trench digger, a sweeper, a plow, a dump bucket, a hole digger, a chipper, and an aerator, but is not so limited and may be nearly any variety of accessory that may be utilized or driven by the tractor 300. Generally, implements have a complementary machine interface that is configured to be engaged with the implement interface 370 in an operational configuration. Further, various implement power couplers can be included to provide hydraulic or electrical signals to or from an associated implement (e.g., the implement 380).

The description of power machine 100 and tractors 200, 300 above is provided for illustrative purposes, to provide illustrative environments on which the examples discussed below can be practiced. While the examples discussed can be practiced on a power machine such as is generally described by the power machine 100 shown in the block diagram of FIG. 1 and more particularly on a compact tractor such as the tractors 200, 300, unless otherwise noted or recited, the concepts discussed below are not intended to be limited in their application to the environments specifically described above.

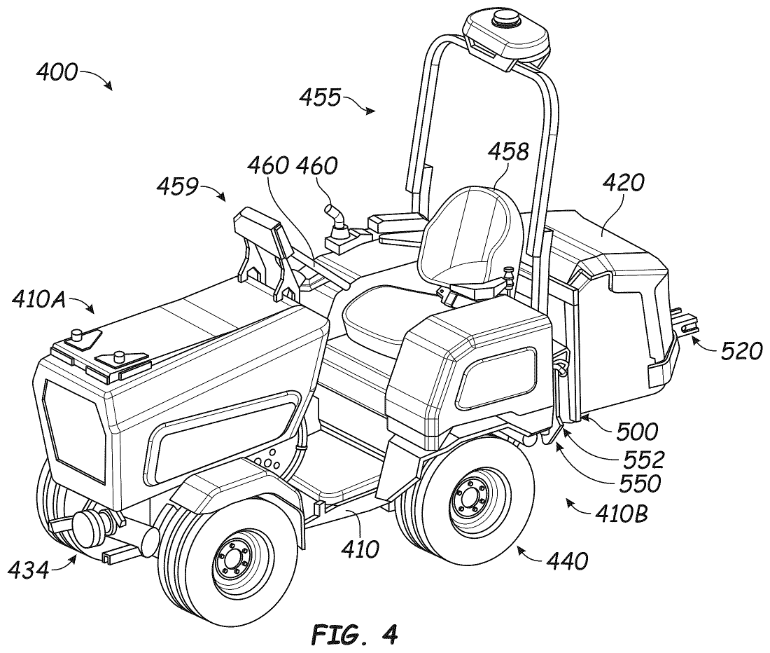

As mentioned above, examples of the disclosed technology can provide a power source that is exchangeable for a different power source—and related support and control systems—thereby providing for improved operation of the compact tractor overall. For example, FIGS. 4-8 illustrate an example compact tractor 400, which is another particular example of the power machine 100 of FIG. 1, the tractor 200 of FIG. 2, or the tractor 300 of FIG. 3. To that end, features of the tractor 400 described below include reference numbers that are generally similar to those used in FIGS. 1-3. For example, the tractor 400 is described as having a frame 410, just as power machine 100 has a frame 110. Correspondingly, discussion of numbered components above also applies to correspondingly numbered components below, unless otherwise noted or required. However, the tractor 400 as illustrated should not be considered limiting, and examples disclosed below can also be practiced on a variety of other power machines.

In the illustrated example, the frame 410 is an articulating frame with a front frame portion 410A that can be moved along one or more degrees of freedom relative to a rear frame portion 410B. For example, the front frame portion 410A can articulate relative to the rear frame portion 410B about an articulating joint that links the front frame portion 410A and the rear frame portion 410B (e.g., pivoted about a vertical or a horizontal axis).

As shown in FIG. 4, the frame 410 of the tractor 400 supports a power source 420 that is capable of generating or otherwise providing power for various functions of the tractor 400. For example, the power source 420 can power a traction system 440 or a work element that is coupled to a PTO interface 434 or otherwise supported (e.g., movably supported by a lift arm (not shown)).

In particular, the power source 420 can include an electric power source in some examples (e.g., a battery assembly, a capacitor, a hydrogen fuel cell, an ethanol fuel cell, a methanol fuel cell, etc.). The power source 420 is supported by the frame 410 and, in the illustrated example, is mounted to the rear frame portion 410B. Correspondingly, in the illustrated example, the power source 420 located rearward of an operator station 455, which can include an operator seat 458 and a plurality of operational input devices to control various work functions of the tractor 400 (e.g., control devices 460, or human-machine interfaces included a touchscreen 459 or other display, etc.).

In the illustrated example, the power source 420 is mounted on a power source frame 500. The tractor 400 can include a battery support assembly 550 including a lift interface 552 that the power source frame 500 can be coupled to. As will be described in greater detail below, the battery support assembly 550 can include a movable lift assembly with a plurality of links that can move relative to one another to move the power source 420 in a generally vertical lift path (e.g., under hydraulic or electric power). The lift assembly can also include a lift actuator that can operate to move the lift assembly including the plurality of links.

In some examples, the power source 420 can further include a power distribution system, a charging system, or a power source management system (e.g., combined in a single integrated system) to enhance operation and management of the power source 420. In some examples, the charging system can control charging current based on a capacity of the power source or can otherwise employ power management approaches as generally known in the art.

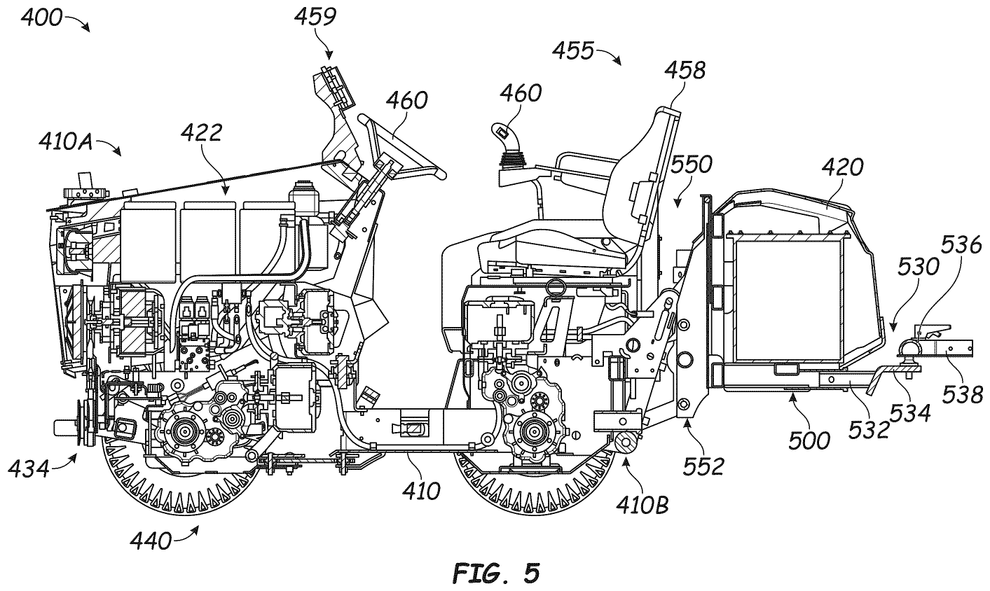

In some implementations, the power source 420 can be exchanged with another power source (e.g., at a charging or docking station, at which the other power sources can be kept at or returned to full charge or otherwise staged for swapping operations). As needed, the battery support assembly 550 can lower the power source 420 to operatively disengage the power source 420 from the tractor 400 (e.g., including disconnecting any electric connection therebetween). A replacement (e.g., pre-charged) power source (e.g., substantially identical to the power source 420) can then be coupled to the tractor 400 at the lift interface 552 and raised into position for operative engagement with the tractor 400. Once an electrical connection is established with the replacement power source, the replacement power source can then deliver energy to the tractor 400. Correspondingly, the capability to swap power sources can advantageously allow for extended (e.g., continuous) operation of the tractor 400. In some examples, the tractor 400 can further include reserve power sources (e.g., batteries 422, see FIG. 5) to supply additional power during operation or continue to provide power during the swapping process.

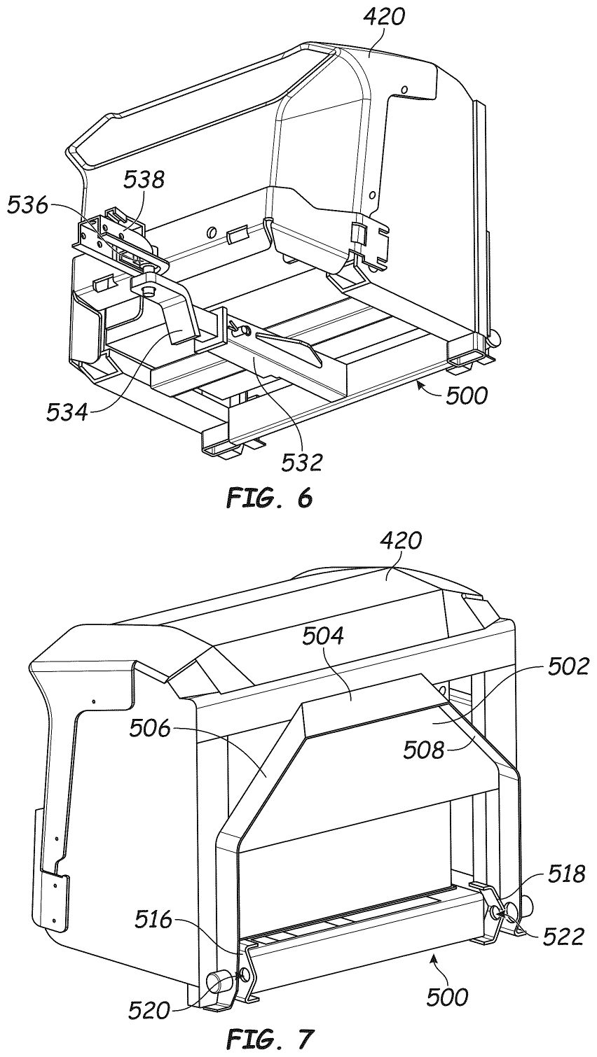

Referring to FIGS. 5 and 6, the power source frame 500 can include a hitch assembly 530 that is capable of towing loads (e.g., a trailer, equipment, etc.) with the tractor 400. In particular, the hitch assembly 530 can include a hitch receiver 532 that can receive (e.g., as shown) a mount 534 with a ball 536, to in turn receive a coupler 538 that can be articulated about the ball 536. The coupler 538 can be latched or mounted to the towing loads (not shown) to secure the towing loads to the tractor 400. In this example, the ball 536 can be located close to the tractor 400 to bring a center of gravity of the tractor 400 toward the middle (e.g., to maintain balanced weight distribution). The hitch assembly 530 can be positioned at a height to provide clearance between the tractor 400 and a terrain (e.g., golf course, uneven topography, etc.). The hitch assembly 530 can be permanently integrated to the power source frame 500 (e.g., via welding) or removably joined. Usefully, including the hitch assembly 530 on the power source 420 can increase the versatility of the tractor 400 overall, while also avoiding the potential for interference between a differently located hitch assembly and the movements of the battery support assembly 550 or the power source 420 itself.

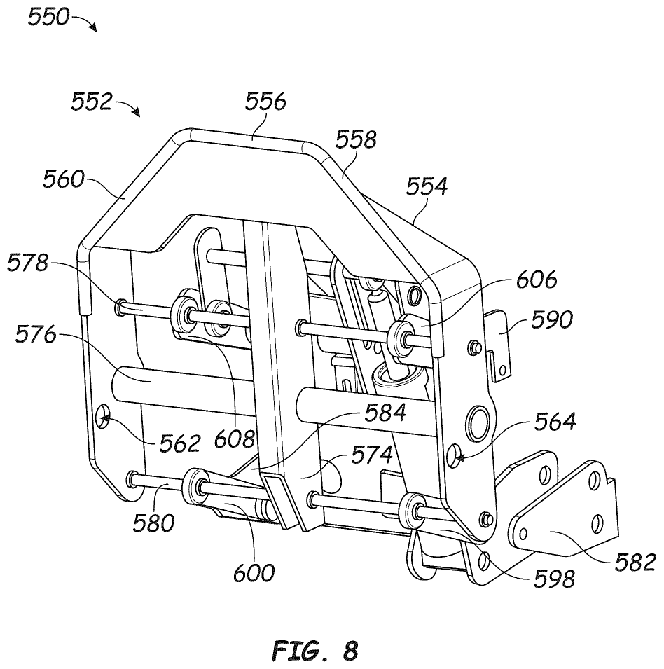

As illustrated in FIG. 7, a front portion of the power source frame 500 can include members with structured geometry to engage with the lift interface 552. For example, the power source frame 500 can include a weldment 502 having a top hook 504 and lateral surfaces 506, 508 that generally correspond to a shape of the lift interface 552. The power source frame 500 can also include flanges 516, 518 that are spaced apart on opposing ends of the power source frame 500. The flanges 516, 518 can include holes 520, 522 that are sized to receive fasteners (e.g., pins) or other locking mechanisms that can be used to secure the power source frame 500 to the lift interface 552 or the power source frame 500. In the example shown, as further discussed below, the weldment 502 can define a peaked shape (e.g., with an apex and lateral profiles) at an upper portion, or otherwise, to help align and secure the weldment 502 with the lift interface 552. In other examples, however, other configurations are possible.

Turning to FIG. 8, an overall shape of the lift interface 552 can be defined by a lift bracket 554 (e.g., another weldment). The lift bracket 554 can be sized and shaped to engage with other parts of the battery support assembly 550 and the power source 420. For example, a top portion of the lift bracket 554 can include a top edge 556 and lateral edges 558, 560 that extend from opposite ends of the top edge 556 with a similar geometry to the top hook 504 and lateral surfaces 506, 508 of the weldment 502 (see FIG. 7). Correspondingly, when the battery support assembly 550 picks up the power source 420 (e.g., at the docking station), the top hook 504 can latch onto the top edge 556, and the lateral surfaces 506, 508 can engage with the lateral edges 558, 560. Further, a top portion of the lift interface 552 can fit within the top portion of the lift bracket 554 and limit side-to-side or front-to-back motions. As also noted above, the peaked shape of the lift interface 552 can assist in alignment and securement of the power source frame 500 with the lift interface 552 (e.g., via mating with the peaked shape of the power source frame 500), although other configurations are possible.

The lift bracket 554 can further include apertures 562, 564 that are configured to be aligned with the respective holes 520, 522 of the flanges 516, 518. The apertures 562, 564 and the holes 520, 522 can laterally receive pins (not shown) to secure or lock the lift interface 552 to the power source frame 500 and, correspondingly, align the power source 420 and the tractor 400. In some examples, the pins (not shown) can be activated by solenoids (not shown). In some cases, providing locking mechanisms as described can permit slight variability in manufacturing of the lift interface 552 and the power source frame 500 (e.g., while ensuring a clearance fit of the parts). Therefore, a robust structural or electrical connection between the power source 420 and the tractor 400 can be achieved with a high degree of precision, despite material wear of some parts due to repetitive use over time.

Continuing, the battery support assembly 550 can include rigid support members, as appropriate, to enhance an overall rigidity of the lift interface 552. For example, the battery support assembly 550 can include a truss 574 that extends vertically through a central portion of the lift bracket 554. A tube 576 can extend horizontally through the truss 574 and lateral sides of the lift bracket 554, and an upper lift rod 578 and a lower lift rod 580 can extend horizontally above and below the tube, respectively. The truss 574, the tube 576, the upper lift rod 578, and the lower lift rod 580 can be arranged so that a shape of the lift bracket 554 is maintained against deformation about one or more axes.

The upper lift rod 578 and the lower lift rod 580 can also be utilized to connect the lift interface 552 with the tractor 400 via interoperation with various links of the battery support assembly 550. For example, the battery support assembly 550 can include lower arms 582, 584 that are anchored to the tractor 400 and lower links 598, 600 that bridge the lower arms 582, 584 and the lower lift rod 580. The battery support assembly 550 can also include upper arms 590 (only one upper arm is shown in FIG. 8) that are anchored to the tractor 400 and upper links 606, 608 that bridge the upper arms 590 and the upper lift rod 578. Thus, when the lower links 598, 600 and the upper links 606, 608 rotate relative to the lower arms 582, 584 and the upper arms 590, respectively, the rotational movement can be translated into generally translational movement to raise the lift interface 552.

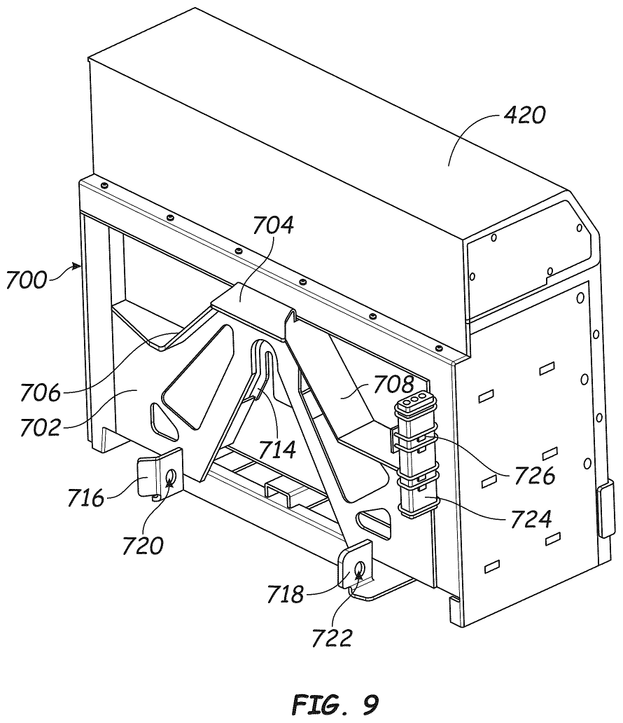

FIGS. 9-11 illustrate an example power source frame 700 and an example battery support assembly 750 with a movable lift assembly, which are particular examples of the power source frame 500 and battery support assembly 550 of FIGS. 4-8. To that end, features of the power source frame 700 and the battery support assembly 750 described below include reference numbers that are generally similar to those used in FIGS. 4-8, and discussion of above applies to similar numbers below unless otherwise noted or required.

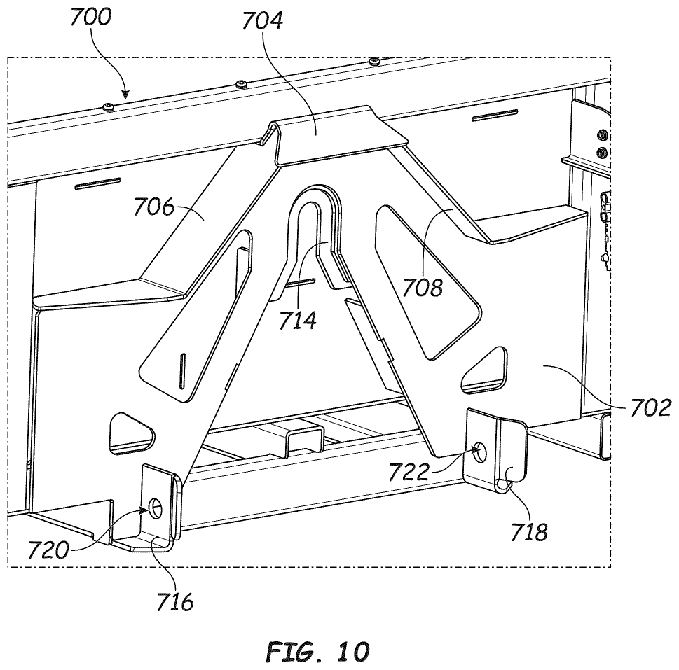

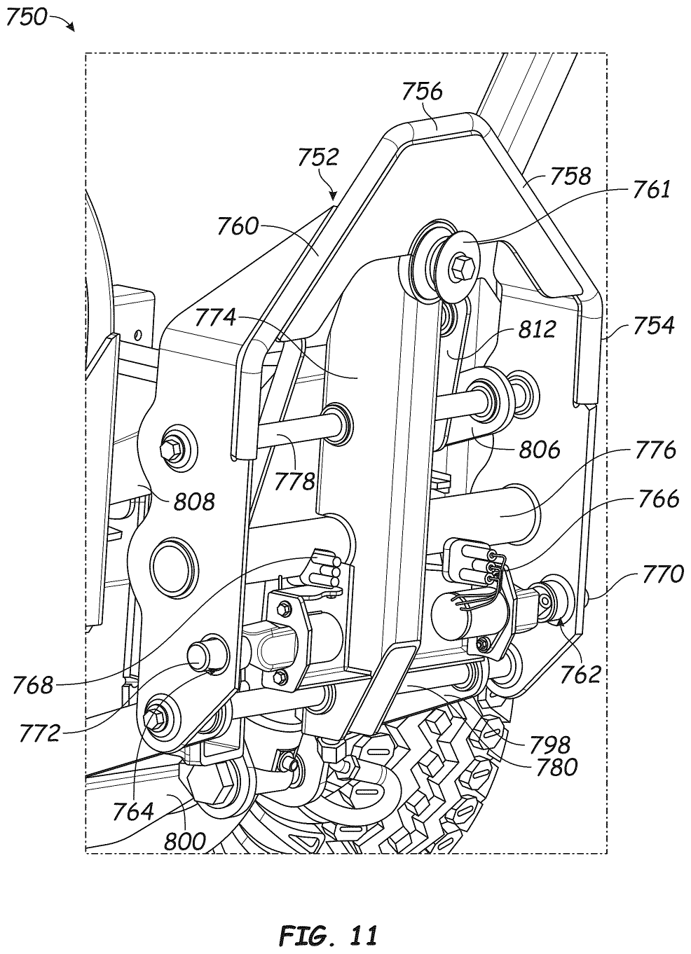

However, in some aspects, the power source frame 700 and the battery support assembly 750 differ from the power source frame 500 and the battery support assembly 550. For example, FIGS. 9-10 show the power source frame 700 including a support bracket (e.g., a panel weldment 702) and a guide 714 (e.g., to provide an angularly tapered, blind-end guide slot, as shown). As similarly described above, the panel weldment 702 can include a hook 704 and lateral surfaces 706, 708 that can engage with corresponding features of a lift interface 752 (shown in FIG. 11) of the battery support assembly 750. The power source frame 700 can further include a guide 714 that can engage with the lift interface 752 for alignment of one another. The power source frame 700 can include flanges 716, 718 with corresponding holes 720, 722 that are sized to receive locking mechanism (e.g., solenoids, shown in FIG. 11) to secure the power source frame 700 to the lift interface 752.

The power source 420 can also be provided with an electrical connector 724 that communicates with a Controller Area Network (CAN) bus (or otherwise) to signal that the tractor 400 has an active electrical connection from the power source 420. In some examples, a first solenoid 726 or other electronic locking device can be provided to activate the connector 724 (e.g., upon operator command, or automatically upon detecting that the power source 420 has been appropriately aligned for powered operations). Correspondingly, when the CAN bus recognizes that the electrical connection has been made, the power source 420 can be turned on or off, or otherwise controllably operated, to selectively distribute power to the tractor 400. While the power source 420 of FIGS. 5-7 is not expressly described as including the first solenoid 726 and the connector 724, the power source 420 can include a similar electronic connection assembly (e.g., solenoid and connector) in some examples, to help ensure reliable electrical connection between the power source 420 and the tractor 400.

With specific reference to FIG. 11, the lift interface 752 can include a bracket 754 that includes a top edge 756 and lateral edges 758, 760 that extend from opposite ends of the top edge 756. A contour of the lateral edges 758, 760 can generally correspond with a contour of the lateral surfaces 706, 708 (see, e.g., FIG. 10). Thus, when the battery support assembly 750 picks up the power source 420, lateral movement of the lift interface 752 can be confined between the lateral surfaces 706, 708. Further, the angled apex profile of the bracket 754 overall can engage with the corresponding angled apex profile of the panel weldment 702 to help self-align (e.g., self-center, as shown) the overall assembly. Thus, it may not be necessary for an operator to precisely align the tractor 400 with the relevant loading area (e.g., docking or charging station).

The lift interface 752 can also include a protrusion 761 that is sized to slide through the guide 714 to align power source frame 700 and the lift interface 752. For example, the protrusion 761 can be formed as an attached, necked pad or boss, as shown in FIG. 11. This engagement between the protrusion 761 and the guide 714 can help to further align (e.g., center) the engagement between the bracket 754 and the panel weldment 702 and the power source 420. As also generally noted above, this can help to assure appropriate and predictable alignment between the battery support assembly 750 and the power source 420.

When the lift interface 752 and the power source frame 700 are mated and aligned, a second solenoid 766 can be controlled (e.g., activated) to send a first pin 770 through the hole 720 and a first aperture 762. Additionally or alternatively, a third solenoid 768 can be activated to send a second pin 772 through the hole 722 and a second aperture 764. Thus, solenoids or other electronic locking devices can be arranged for movement of corresponding locking members (e.g., pins, cams, etc.) into and out of an engaged position to secure the power source frame 700 to the lift interface 752. While solenoids are used in this example, other types of locking mechanism—such as fasteners or motors—can be used to secure the power source 420 relative to various parts of the power machine frame actively or passively.

The lift interface 752 can also include a truss 774 and a tube 776 to enhance structural integrity of the bracket 754. An upper lift member (e.g., rod 778) and a lower lift member (e.g., rod 780) can be provided to receive various links to connect the battery support assembly 750 to the tractor 400. For example, the lower lift rod 780 can receive lower links 798, 800 that are connected to lower arms (not shown) that are anchored to the tractor 400. The upper lift rod 778 can receive upper links 806, 808 that are connected to upper arms (not shown) that are anchored to the tractor 400. Correspondingly, the battery support assembly 750 can lift the power source 420 relative to anchor (e.g., fixed) points of the lower arms 782, 784 and the upper arms 790, 792.

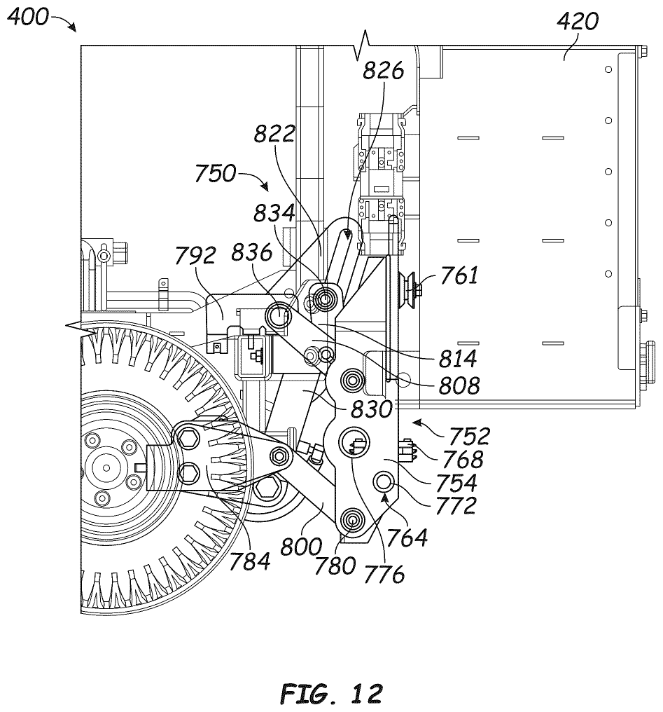

FIGS. 12-17 illustrate operational views of the battery support assembly 750 at different positions. As generally described above, the battery support assembly 750 can be a multi-bar (e.g., four-bar) linkage system including various fixed and movable links that result in one or more degrees of freedom, and examples below discuss a particular four-bar linkage as illustrated in FIGS. 12-17. Correspondingly, in some examples, the battery support assembly 750 can include fixed links including the lower arms 782, 784, the upper arms 790, 792, and plates 820, 822. In some examples, the battery support assembly 750 can include movable links including the lower links 798, 800, the upper links 806, 808, and offset links 812, 814. In other examples, a variety of other link arrangements are possible, including as known in the art for particular prescribed movements.

In particular, in the illustrated example, the upper arms 790, 792 and the lower arms 782, 784 can be vertically distanced apart and rigidly fixed to the tractor 400. The battery support assembly 750 can include an extendable actuator or a lift actuator, including electric or hydraulic actuators, that move between a contracted position and an extended position to lower and raise the battery support assembly 750 (e.g., a cylinder 830 having a piston 832).

In the example illustrated, the cylinder 830 is fixed at an end near the lower arm 782, and an end of the piston 832 is connected to a guide member (e.g., a guide rod 834) that is configured to slide within slots 824, 826 of the plates 820, 822. At the fully lowered position of the battery support assembly 750, the piston 832 can be fully contracted, and the guide rod 834 can contact lower ends of the slots 824, 826.

At one end, the upper links 806, 808 can be pivotally linked to the upper arms 790, 792 via an anchor member (e.g., rod 836) and, at an opposite end, the upper links 806, 808 can be pivotally linked to the bracket 754 via the upper lift rod 778. The offset links 812, 814 can be pivotally connected to the upper links 806, 808 at points between the two opposing ends of the upper links 806, 808, rearwardly offset from the upper arms 790 toward the bracket 754 (e.g., by more than half the length of the upper links 806, 808, as shown). The offset links 812, 814 can be pivotally connected (e.g., inward of) the upper links 806, 808 and extend to provide an offset connection between the upper links 806, 808 and the guide rod 834. Accordingly, as the piston 832 moves between the extended and contracted positions, the offset links 812, 814 can move with the guide rod 834.

At one end, the lower links 798, 800 can be pivotally linked to the lower arms 782, 784 between two plates of the lower arms 782, 784. The opposite ends of the lower links 798, 800 can be pivotally linked to the bracket 754 via the lower lift rod 780. At the fully lowered position of the battery support assembly 750, the upper links 806, 808 and the lower links 798, 800 extended generally downward relative to the tractor 400. Thus, an angle between the lift interface 752 and the upper and the lower links 798, 800 can be acute.

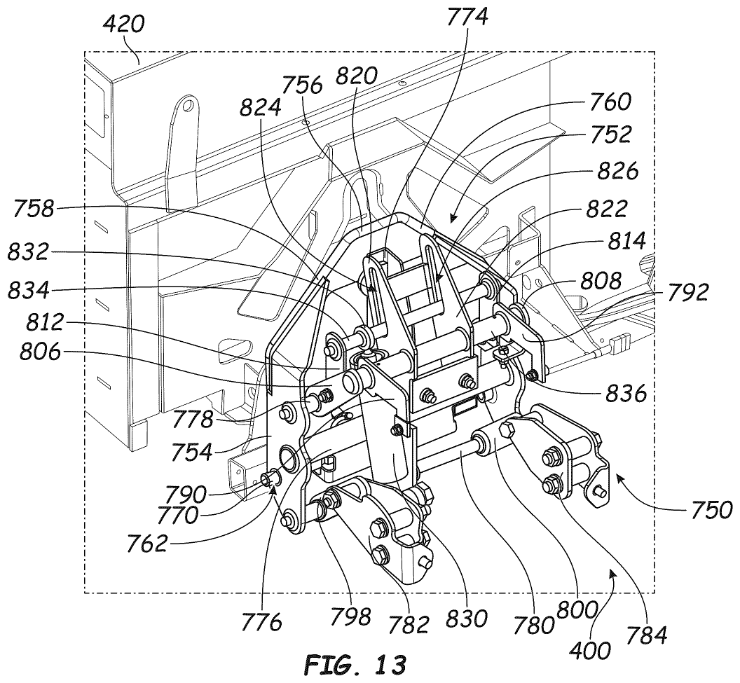

At the fully lowered position shown in FIGS. 12 and 13, the battery support assembly 750 can be aligned with the power source 420 to align the lift interface 752 with the power source frame 700 (e.g., aligned via manual or automated maneuvering of the tractor 400). For example, the angled apex profile of the bracket 754 (see, e.g., FIG. 11) can be aligned for engagement with the angled apex profile of the panel weldment 702 (see, e.g., FIG. 10) as also described above. In some examples, the bracket 754 may be configured to tilt rearwardly relative to vertical in the fully lowered position—and may correspondingly tilt rearwardly toward the panel weldment 702, as lowered toward the lowered position—which may further assist in aligning the corresponding profiles of the bracket 754 and the panel weldment 702 for engagement.

Once aligned, the second and third solenoids 766, 768 can be activated to secure the lift interface 752 to the power source frame 700. In some cases, the first solenoid 726 can also (or alternatively) be activated to establish an electrical connection, although some implementations may operate to fully align the power source 420 for operation with the tractor 400 before establishing an electrical connection between the two (e.g., using the first solenoid 726) (e.g., for transmission of power from the power source 420 to power work elements).

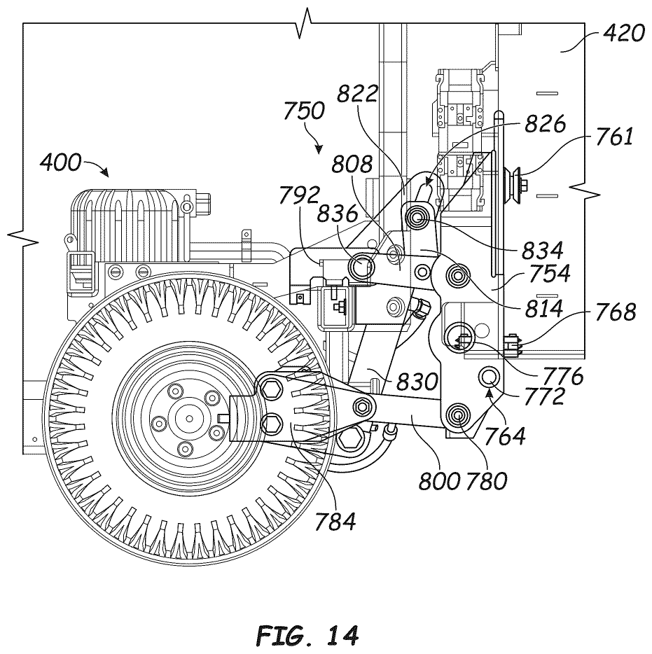

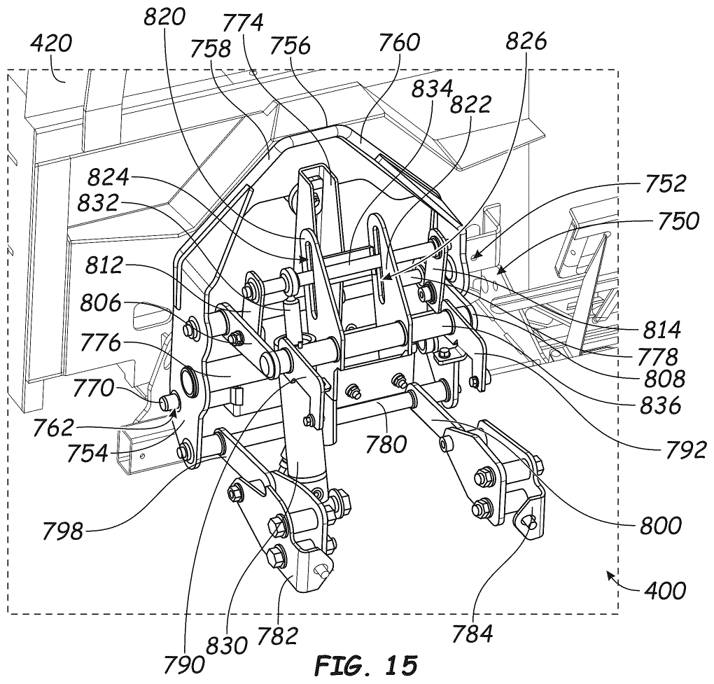

FIGS. 14 and 15 illustrate the battery support assembly 750 in an intermediate position. For example, the piston 832 can be in a mid-stroke, between the contracted position and the extended position. The extension of the piston 832 can lift the guide rod 834, guided by the slots 824, 826, and correspondingly apply lift force to the offset links 812, 814. Due to the rearward position of the offset links 812, 814, and a lifting torque can thus be produced on the upper links 806, 808 about the anchored points of the upper links 806, 808. Thus, the guided translation of the offset links 812, 814 (relative to the plates 820, 822) under power from the piston 832 can cause an upward rotation of the upper links 806, 808. When a sufficient amount of torque is transmitted to the upper lift rod 778 (e.g., enough to overcome a weight of the battery support assembly 750), the battery support assembly 750 can be raised as a result. The torque can also be distributed to the lower lift rod 780 via the bracket 754, raising the lower links 798, 800 upward by the same degree as the upper links 806, 808.

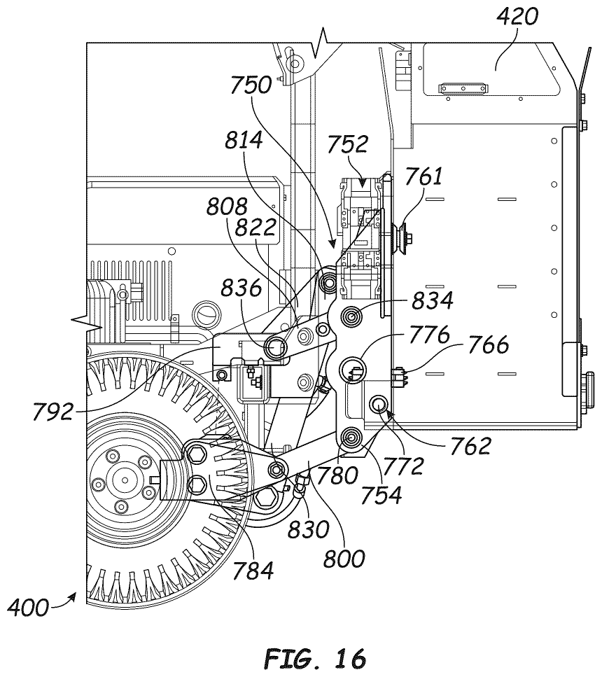

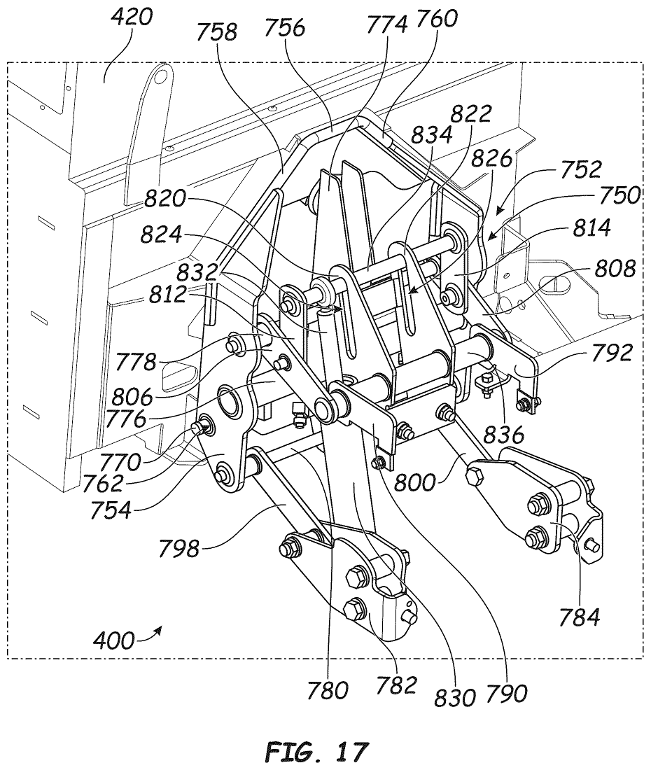

FIGS. 16 and 17 illustrate the battery support assembly 750 in a fully raised position. For example, the piston 832 can be fully extended, and the guide rod 834 can contact upper ends of the slots 824, 826. At the fully raised position of the battery support assembly 750, the upper links 806, 808 and the lower links 798, 800 extended generally upward relative to the tractor 400. Thus, an angle between the lift interface 752 and the upper and the lower links 798, 800 can be obtuse. Advantageously, the disclosed four-bar linkage system can allow for primarily vertical travel during a swapping operation while maintaining the power source 420 leveled relative to the tractor 400. Thus, for example, the illustrated and described aspects of the battery support assembly 750 and the power source frame 700 can individually and collectively allow for more compact space requirements for swapping operations, less rigorous requirements regarding alignment of the tractor 400 with the power source 420, and reduced moment loading of the tractor 400 by the power source 420 during swapping operations.

As needed, the operations discussed above can be generally reversed in order. For example, when the power source 420 is ready to be exchanged for another (e.g., more fully charged) power source, the connector 724 can be disengaged (see, e.g., FIG. 9) to electrically disconnect the power source 420 from the tractor 400, and the battery support assembly 750 can be lowered by moving the piston 832 to the contracted position (see, e.g., FIG. 12). When the battery support assembly 750 is fully lowered, the power source 420 can be disengaged from the battery support assembly 750 at the lift interface 752. Then, the battery support assembly 750 can pick up another power source (e.g., substantially identical to the power source 420) by securing the corresponding power source frame to the lift interface 752 (e.g., after an intervening maneuvering of the tractor 400 or the replacement power source).

Although the presently disclosed technology has been described by referring preferred examples, workers skilled in the art will recognize that changes may be made in form and detail without departing from the scope of the discussion. In this regard, details presented relative to any of the examples discussed herein can be implemented independently or in various combinations (e.g., with aspects of any one of linkages of the lift assembly implemented independently or in combination with aspects of any one or more other of the linkages).

As used herein in the context of a power machine, unless otherwise defined or limited, the term “lateral” refers to a direction that extends at least partly to a left or a right side of a front-to-back reference line defined by the power machine. Accordingly, for example, a lateral side wall of a cab of a power machine can be a left side wall or a right-side wall of the cab, relative to a frame of reference of an operator who is within the cab and is oriented to operatively engage with controls of an operator station of the cab.

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

Some methods of the disclosed technology may be presented above or below with operations listed in a particular order. Unless otherwise required or specified, the operations of such methods can be implemented in different orders, in parallel, or as selected sub-sets of one or more individual operations (e.g., with a particular listed operation being implemented alone, rather than in combination with others).

What is claimed is:

1. A power machine comprising:
a power machine frame that supports one or more work elements; and
a support assembly that includes:
a lift assembly that is secured to the power machine frame and includes at least one movable link and a lift actuator; and
a lift bracket that is movably supported relative to the power machine frame by the at least one movable link; and
a power source that includes:
a power source frame that includes a support bracket; and
an electrical power source supported by the power source frame;
the electrical power source being supported by the support assembly to power the one or more work elements;
the lift bracket removably engaging the support bracket to support the power source relative to the power machine frame with the lift assembly selectively in any of: a raised position, a lowered position, and a plurality of intermediate positions between the raised and lowered positions; and
the lift actuator being operable to move the lift assembly, including the at least one movable link, through the intermediate positions between the raised and lowered positions.

2. The power machine of claim 1, wherein the power machine frame is an articulated frame, with a front frame pivotable relative to a rear frame; and
wherein the support assembly is supported on the rear frame.

3. The power machine of claim 1, wherein the lift assembly includes a multi-bar linkage that includes the at least one movable link.

4. The power machine of claim 3, wherein the multi-bar linkage is configured to tilt a top end of the lift bracket to towards the support bracket as the lift assembly lowers toward the lowered position.

5. The power machine of claim 1, wherein the lift actuator is pivotally secured at a first end relative to the power machine frame and is pivotally secured at a second end to the lift assembly.

6. The power machine of claim 5, wherein the lift actuator is pivotally secured to an upper link of a four-bar linkage of the lift assembly via a pivoting offset link.

7. The power machine of claim 5, wherein the support assembly includes a guide plate with a guide slot, rigidly secured relative to the power machine frame; and
wherein the lift actuator is pivotally secured to the lift assembly via a guide member that extends through the guide slot.

8. The power machine of claim 1, wherein the lift bracket defines a peaked bracket profile;
wherein the power source frame defines a peaked frame profile; and
wherein the peaked bracket profile is received into the peaked frame profile to support the power source relative to the power machine frame.

9. The power machine of claim 8, wherein the power source frame includes a tapered guide and the lift bracket includes a protrusion, the protrusion being arranged to move through the tapered guide to align the peaked frame profile with the peaked bracket profile.

10. The power machine of claim 1, wherein one or more of the support assembly, the power machine frame, or the power source supports a locking member arranged for movement into and out of an engaged position to secure the power source relative to the power machine frame.

11. The power machine of claim 1, wherein one or more of the power machine frame or the support assembly supports a first electrical connector;
wherein the power source includes a second electrical connector; and
wherein the lift assembly supports the power source to align the first electrical connector and the second electrical connector for operational connection to power the one or more work elements.

12. The power machine of claim 11, further comprising:
an electronic locking device arranged to engage the first and second electrical connectors together for transmission of power from the power source to power the one or more work elements.

13. A support assembly for an electrical power source of a power machine, the support assembly comprising:
a lift assembly that is securable to a power machine frame of the power machine at first pivotable joints and includes a four-bar linkage and a lift actuator arranged to move the four-bar linkage relative to the first pivotable joints; and
a lift bracket that is movably supported by the four-bar linkage and includes a peaked profile configured to be received into a peaked profile of a power source that includes the electrical power source.

14. The support assembly of claim 13, further comprising one or more solenoid assemblies configured to one or more of: selectively secure the electrical power source to the lift bracket, or engage an electrical connector of the support assembly with the electrical power source to receive power from the electrical power source.

15. The support assembly of claim 13, wherein the lift bracket includes a protrusion that is configured to align the peaked profile of the lift bracket with the peaked profile of the power source, and the lift bracket is configured to tilt rearwardly as the lift assembly moves the four-bar linkage to lower the lift bracket.

16. A method of swapping a power source for a power machine, the method comprising:
aligning the power machine with the power source so that a support bracket of the power source is aligned with a lift assembly of a battery support assembly secured to a power machine frame of the power machine;
engaging a lift bracket of the lift assembly with the support bracket of the power source so that the lift assembly supports the power source relative to the power machine frame, including an electrical power source supported by a power source frame of the power source; and
operating a lift actuator of the lift assembly to move the lift assembly from a lowered position, through a plurality of intermediate positions, to a raised position for operation of the power machine under power from the electrical power source.

17. The method of claim 16, wherein aligning the support bracket with the lift assembly aligns a peaked profile of the lift bracket to be received into a peaked profile of the support bracket.

18. The method of claim 17, wherein lowering the lift assembly to the lowered position causes a top end of the lift bracket to tilt towards the support bracket to align the peaked profiles.

19. The method of claim 16, further comprising:
after engaging the lift bracket with the support bracket, operating a first electronic locking device to secure the support bracket to the lift bracket.

20. The method of claim 19, further comprising:
after operating the first electronic locking device to secure the support bracket to the lift bracket, operating a second electronic locking device to electrically connect the power source for transmission of power to one or more work elements of the power machine.
